(19) United States
(12) Patent Application Publication
(10) Pub. No.: US 2023/0337821 A1
(43) Pub. Date: Oct. 26, 2023

(54) TELEVISION OR DISPLAY WALL MOUNTING BRACKET

(71) Applicant: TechKrew LLC, Portland, OR (US)

(72) Inventor: Kurt Welty, Portland, OR (US)

(21) Appl. No.: 17/660,183

(22) Filed: Apr. 21, 2022

(51) Int. Cl. A47B 97/00; F16M 13/02

(52) U.S. Cl. CPC A47B 97/001; F16M 13/02; F16M 2200/061

(57) ABSTRACT

A television or display mounting bracket having scissor arms interconnected with one another and to a mounting plate, an intermediary plate connected to the scissor arms, at least one rotating arm pivotally connected to the intermediary plate, and at least one pivoting connector of the at least one rotating arm configured to be connectable to the television or display so that the television or display, when connected to the at least one pivoting connector, is movable in relation to the vertical surface via the plurality of scissor arms and, independently, via the at least one rotating arm.

### CROSS-REFERENCE TO RELATED APPLICATIONS

None.

### TECHNICAL FIELD

The present disclosure relates to improving a television (or TV) or display mounting bracket (or rack), and, more particularly, to improving the rotative and expansive motion of a wall mountable video display or television bracket so that the display or television screen may be moved (horizontally) away from and (rotatively vertically) downward from the wall, to viewing positions away from, for example, a mantel or other wall-positioned furniture.

### BACKGROUND AND SUMMARY

Television or display mounting brackets typically provide for limited movement of the television or display screen. Available mounting brackets allow for mounting, for example, an LED or other type of television or display screen on a vertical wall. Existing brackets are available that provide a limited tilt of the display screen. For example, brackets exist that provide a limited tilt rotation about a horizontal x-axis so as to angle the display viewing plane with respect to a horizontal x-y planar surface such as a floor and a z-x planar surface such as a wall. Such brackets allow for neither movement of the screen in toward and outward from (along a horizontal y-axis) the z-x plane (e.g., wall) nor any movement of the screen in an upward or downward (along a vertical z-axis) direction. Further, such brackets typically provide only very limited, if any, rotation of the display screen about the vertical z-axis (so as to angle the screen to the right or left for viewing positions in locations with respect to the x-y planar surface (e.g., with respect to the floor).

Other available display screen wall mounting brackets are advertised as full-motion brackets, providing for movement of the screen inward and outward from a wall (i.e., providing movement of the screen along a y-axis directed orthogonal to the z-x plane of the wall) and for movement of the screen to varying extents right or left along an x-axis horizontal and parallel to the x-y plane or floor. Such so-called full-motion brackets may further provide for pivoting (rotating) the display screen right or left so as to angle the viewing plane (i.e., the z-x plane of the television or display screen viewing area) about the vertical z-axis, yet do not allow for vertical repositioning of the display screen in the vertical z-axis direction.

The present inventor determined that existing TV mounting systems do not satisfactorily account for the (vertically) higher positioning of the TV when mounted over, for example, a fireplace mantel or other obstruction or furniture. The present inventor determined that such mounting positions, while common, are simply uncomfortably too high and provide unsatisfactory TV viewing ergonomics, and available TV or display mounting systems are not available that satisfactorily provide for repositioning the TV or display screen. Television or display screen wall mounting bracket structures that may comprise pairs of parallel arms to allow for vertical repositioning of the display screen in the vertical z-axis direction (e.g., upward or downward, away from or closer to, the floor), the present inventor determined, do not allow for pivoting the screen about a vertical z-axis, adequate repositioning of the screen inward and outward away from the wall mounting surface in a horizontal y-axis direction, or movably mounting (or hanging) the television (or television screen, or display, or display screen) above, for example, a fireplace mantel or similar structure that may extend outward away from the vertical mounting surface.

What is needed are designs for a television or display mounting bracket or rack that provide a greater range of motion and repositioning capabilities in terms of movement along a horizontal inward and outward (or y-axis) direction, movement along a vertical upward or downward (or z-axis) direction, pivoting right or left about a vertical z-axis, and tilting (pivoting) up or down about horizontal x-axis, and that comprise structure configured to permit the effective and improved repositioning functionality when mounted to a vertical surface (wall) over a mantel surface or other obstruction. That is, a television wall mounting rack is needed that is configured for improved movement grow lights are needed that deliver more light at the edges or toward the edges so as to a greater amount of light is delivered to the target grow area.

To address at least some of the aforementioned and other problems, embodiments are provided for a television or video display wall mounting bracket or rack having improved rotative and expansive motion so that the display or television screen may be moved (horizontally) away from and (rotatively vertically) downward from the wall, to viewing positions away from, for example, a mantel or other wall-positioned furniture.

According to one aspect, a television or display mounting bracket comprises a mounting plate configured to be mountable to a vertical surface, a plurality of scissor arms interconnected with one another and to the mounting plate so that the plurality of scissor arms moves within a scissors plane that is non-parallel to the vertical surface, an intermediary plate connected to at least one of the plurality of scissor arms and configured to move within the scissors plane along with the at least one of the plurality of scissor arms, at least one rotating arm pivotally connected to the intermediary plate and configured such that each of the at least one rotating arm moves within a rotating arm plane that is non-parallel to the scissors plane, and at least one pivoting connector of the at least one rotating arm configured to be connectable to the television or display so that the television or display, when connected to the at least one pivoting connector, is movable in relation to the vertical surface via the plurality of scissor arms and, independently, via the at least one rotating arm.

According to an aspect, the scissors plane is orthogonal to the vertical surface, whereby the intermediary plate is extendable within the scissors plane so as to selectively extend the intermediary plate away from the mounting plate and retract the intermediary plate toward the mounting plate, thereby varying a distance between the vertical surface and the intermediary plate.

According to an aspect, the vertical surface comprises a wall surface and the scissors plane is horizontal and parallel with a floor surface, and wherein the mounting bracket permits extending the television or display, when connected to the mounting bracket via the at least one pivoting connector, outward from or inward to the wall within a horizontal range of motion parallel to the floor.

According to an aspect, the rotating arm plane is orthogonal to the scissors plane, whereby the at least one rotating arm is pivotally rotatable with respect to an axis of rotation on the intermediary plate so as to permit the at least one rotating arm to rotate between at least an upward or vertical position and an outward position, wherein, in the upward or vertical position, the at least one rotating arm is oriented such that the at least one pivoting connector is closer to the vertical surface than when the at least one rotating arm is in the outward position.

According to an aspect, the vertical surface comprises a wall surface and the scissors plane is horizontal and parallel with a floor surface, wherein the mounting bracket permits extending the television or display, when connected to the mounting bracket via the at least one pivoting connector, outward from or inward to the wall within a horizontal range of motion parallel to the floor surface via movement of the plurality of scissor arms, wherein the axis of rotation of on the intermediary plate is horizontal and parallel with the floor surface, and wherein the at least one rotating arm is rotatable about the axis of rotation of the intermediary plate so that the television or display, when connected to the mounting bracket via the at least one pivoting connector, is movable along an arc within the rotating arm plane in order to reposition the television or display farther outward from the wall and vertically downward toward the floor surface as the at least one rotating arm moves from the upward or vertical position to the outward position.

According to an aspect, the mounting plate comprises one or more planar structure to which the plurality of scissor arms are interconnected.

According to an aspect, the plurality of scissor arms comprises a pair of scissor arms interconnected with one another so that one end of the pair of scissor arms connects to the mounting plate and another end of the pair of scissor arms connects to the intermediary plate and so as to permit the intermediary plate to be selectively moved away from or moved closer to the mounting plate.

According to an aspect, the pair of scissor arms comprises a pair of articulated arms, the pair of articulated arms having a first arm pivotally attached to the mounting plate, a second arm pivotally attached to the first arm, and the second arm pivotally attached to the intermediary plate.

According to an aspect, the scissor arms are interconnected with the mounting plate and the intermediary plate so as to permit the scissor arms to move within a horizontal plane that is orthogonal to the vertical surface and parallel to a floor surface.

According to an aspect, the intermediary plate comprises a horizontally oriented axis of rotation and the at least one rotating arm comprises a pair of rotating arms with each rotating arm pivotally connected to the intermediary plate via the horizontal axis of rotation and configured so that both rotating arms move together in relation to one another so that the television or display, when connected to the mounting bracket via the at least one pivoting connector, is movable along an arc within the rotating arm plane in order to reposition the television or display farther outward from the wall and vertically downward toward the floor surface as the at least one rotating arm moves from the upward or vertical position to the outward position.

According to an aspect, the at least one rotating arm comprises a longitudinally extending arm pivotally connected to the intermediary plate at a rotating arm pivot point at one end and having one of the at least one pivoting connector at the other, wherein the rotating arm pivot point includes a piston or spring force configured to urge rotation of the rotating arm toward the upward or vertical position and resist rotation of the rotating arm toward the outward position.

According to an aspect, the television or display comprises an x-y-z coordinate system wherein an x-axis comprises a width of the television or display and is horizontal and parallel to the floor, a y-axis is orthogonal to the x-axis and extends between a front and a rear surface of the television or display, a z-axis is orthogonal to the x-axis and the y-axis and extends vertically between a top edge and a bottom edge of the television or display, wherein the bracket allows for repositioning the television or display in a y-axis direction via the scissor arms and rotating the television or display within an arc in a z-y plane, wherein the vertical surface comprises a z-x plane that is orthogonal to a horizontal or floor surface that comprises an x-y plane, wherein the bracket is configured so as to be movable in the y-axis direction away from the vertical surface via the scissor arms, and, independent of the movement in the y-axis direction via the scissor arms, movable about an arc of rotation about an x-axis.

According to an aspect, a method of using a television or display mounting bracket includes providing a television or display and attaching the television or display to a wall using a television or display mounting bracket as previously described, pulling the television or display outward in the y-direction, rotating the television or display outward and downward in the arc in the z-y plane; and tilting the television or display by rotating the television or display about the x-axis.

According to an aspect, moving the television or display in y-direction comprises pulling the television or display away from wall to a distance sufficient to clear a top surface and front edge of a mantel positioned vertically below the mounting bracket.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The accompanying drawings are incorporated herein as part of the specification. The drawings described herein illustrate embodiments of the presently disclosed subject matter, and are illustrative of selected principles and teachings of the present disclosure. However, the drawings do not illustrate all possible implementations of the presently disclosed subject matter, and are not intended to limit the scope of the present disclosure in any way.

FIG. 1 is an elevation view of a television or display attached to a wall above a mantel and fireplace using a television or display mounting bracket according to various embodiments.

FIG. 2 is a perspective view from above showing a television or display mounting bracket in a substantially collapsed or stowed position where a scissors portion is collapsed and a rotative (rotating) arm portion is in an upward or vertical stowed position, according to embodiments.

FIG. 3 is a perspective view from above showing a television or display mounting bracket with a scissors portion in an extended position to move the television or display away from a vertical surface mounting plate and with a rotative (rotating) arm portion in an upward or vertical (stowed) position, according to embodiments.

FIG. 4 is a perspective view from above showing a television or display mounting bracket with a scissors portion in an extended position to separate a mounting plate and an intermediary plate, and with a rotative (rotating) arm portion rotated from an upwright or vertical position to an outward positon such that the television or display is away from and downward in relation to the intermediary plate, according to embodiments.

FIG. 5 is a perspective view from above and in front of a television or display attached to rotative (rotating) and scissors portions of a television or display mounting bracket adapted for attaching the television or display to a wall or vertical surface, and depicting the television or display in a vertically lower position relative to the wall or vertical surface mounting plate than when the rotating arms (rotative portion) are in an upward or vertical orientation relative to the wall and intermediary plate, according to embodiments.

Similar reference numerals may have been used in different figures to denote similar components.

### DETAILED DESCRIPTION

It is to be understood that the disclosure may assume various alternative orientations and step sequences, except where expressly specified to the contrary. It is also to be understood that the specific assemblies and systems illustrated in the attached drawings, and described in the following specification are simply exemplary embodiments of the inventive concepts defined herein. Hence, specific dimensions, directions or other physical characteristics relating to the embodiments disclosed are not to be considered as limiting, unless expressly stated otherwise. Also, although they may not be, like elements in various embodiments described herein may be commonly referred to with like reference numerals within this section of the application.

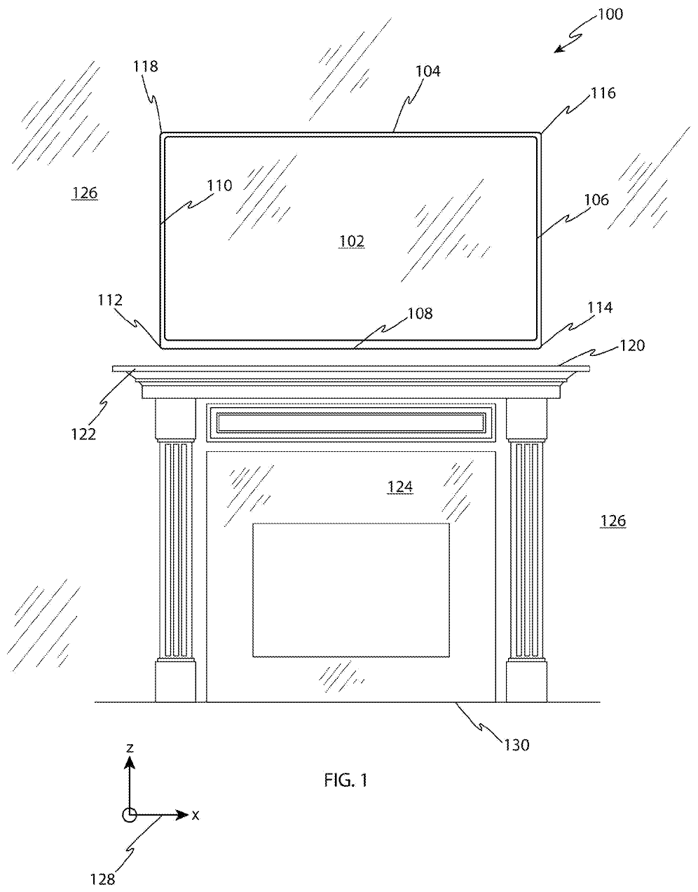

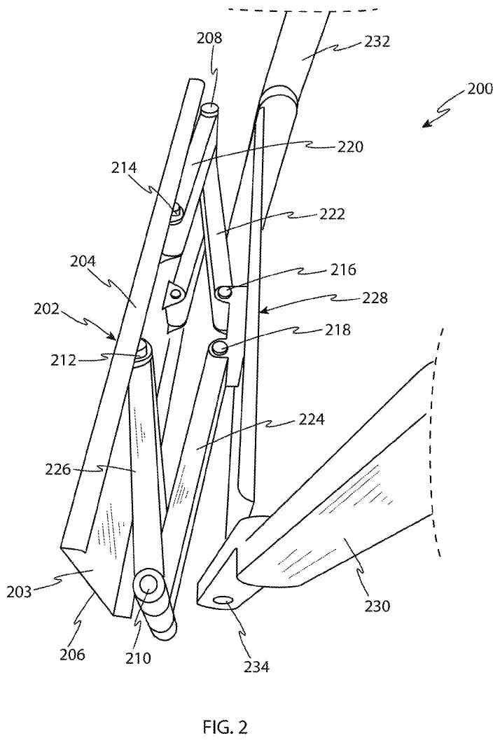

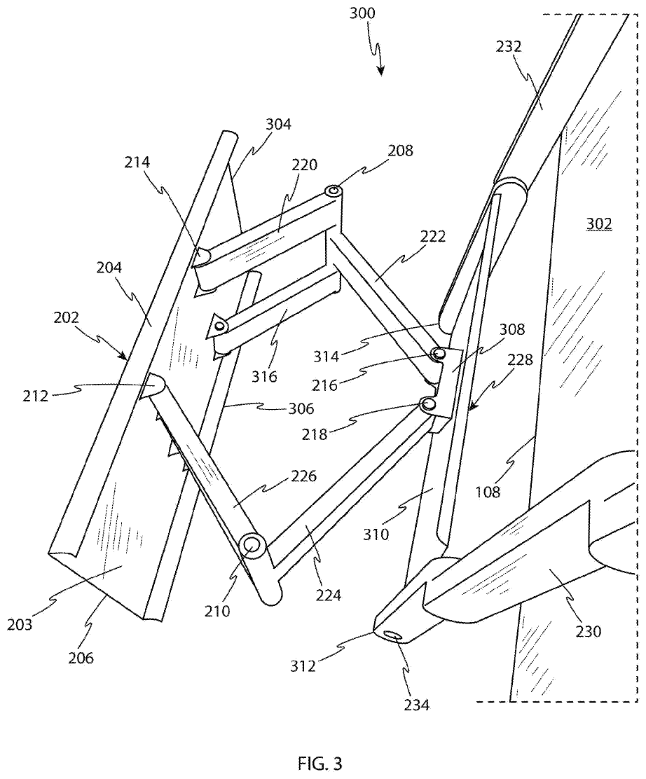

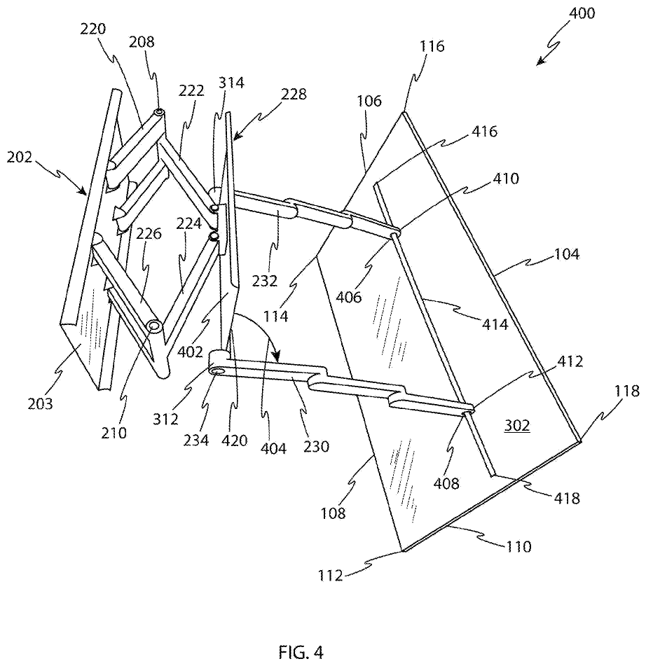

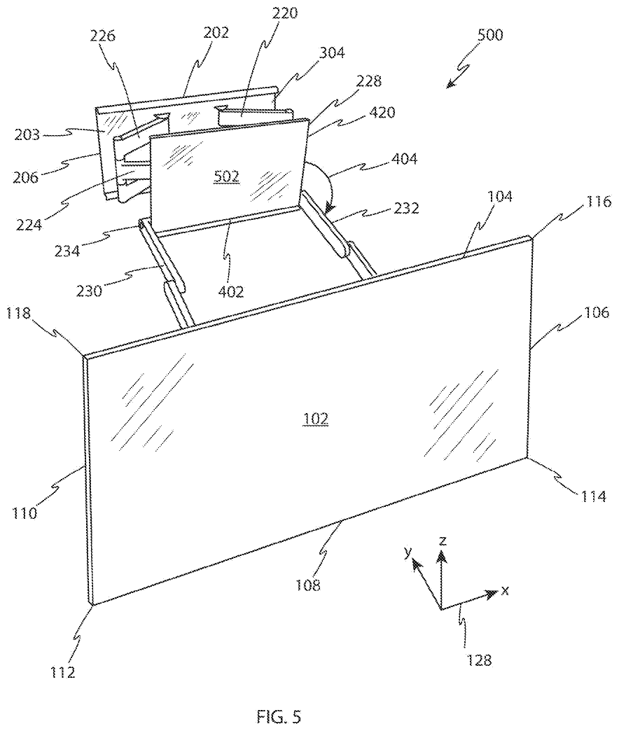

As an overview, FIG. 1 illustrates a television or display mounted on a wall above a mantel and fireplace, and FIGS. 2-5 illustrate a mounting bracket attaching the television or display to the wall, illustrated in progressively outward and then outward and downward extending positions in relation to the vertical mounting plate of the mounting bracket affixed to the wall. As shown in FIGS. 2 and 3, the mounting bracket includes a scissors (scissor arms) portion that permits the television or display to be pulled outward from the wall; and, then, as shown in FIGS. 4 and 5, the mounting bracket includes a rotative (rotating arms) portion that permits the television or display to be repositioned farther outward and downward so that the television or display is in a lower vertical position than when the rotative arms are in an upward or vertical position. The result, as depicted in FIG. 5, is a television or display mounting bracket that allows for mounting the television or display on a wall or vertical surface above a mantel of a fireplace or another feature or item of furniture or the like, whereby the television or display may be selectively repositioned from a position above the mantel with the mounting bracket in a fully compressed or collapsed orientation, to a position out from the wall and lowered downward in relation to the mantel so that the bottom of the television or display may be positioned vertically below (and avoid contact with) the fireplace mantel.

FIG. 1 is an elevation view 100 of a television or display attached to a wall 126 above a mantel 120 and fireplace 124 using a television or display mounting bracket according to various embodiments. The television or display has a front surface 102 between top and bottom edges 104 and 108, respectively, and left and right side edges 110 and 106, respectively. The television or display may be shaped differently than shown; however, for purposes of the disclosure herein the television or display generally comprises a rectangular screen area or front surface 102. The front surface 102 may or may not be planar; however, again for purposes of the disclosure herein a television or display with a generally flat or planar screen or front surface 102 is described.

The orientation and arrangement of the television or display and a mounting bracket therefor, are described herein in the context of an x-y-z coordinate reference or system 128. The wall 126 comprises a planar vertical surface having a z-x plane (or being parallel to a z-x plane). A width of the television or display, as shown, is a distance between the left side edge 110 and the right side edge 106, or the width 112-114 along the bottom edge 108 of the television or display extending between corners 112 and 114 (or the width 118-116 along the top edge 104 of the television or display extending between corners 118 and 116). As depicted in FIG. 1, the top and bottom edges 104 and 108, respectively, are parallel to the x-axis, or horizontal, and parallel to the floor or floor surface 130, with the floor 130 comprising a surface having an x-y plane or being parallel to an x-y plane (in relation to the x-y-z coordinate system 128).

The top edge 104 and bottom edge 108 are shown in FIG. 1 as being parallel to one another and parallel to the x-axis or x-axis direction (in relation to the x-y-z coordinate system 128). A height of the television or display, as shown, is a distance between the top edge 104 and the bottom edge 108, or the height 112-118 along the left side edge 110 of the television or display extending between corners 112 and 118 (or the height 114-116 along the right side edge 106 of the television or display extending between corners 114 and 116). As depicted in FIG. 1, the left and right side edges 110 and 106, respectively, are parallel to the z-axis, or vertical, and perpendicular (orthogonal) to the floor or floor surface 130.

A depth of the television or display may be defined as a distance between the front screen (front surface) 102 and a back of the television or display, with the depth dimension extending along a y-axis or in a y-axis direction from the z-x plane of the front surface 102 toward the z-x plane of the vertical surface or wall 126.

As is described in further detail below, a mounting bracket for the television or display permits the television or display (which may be referred to using reference numeral 102, used also for referring to the front surface or screen of the television or display), according to embodiments described herein, to be repositioned outward in a horizontal (y-axis direction) away from the x-z plane of the wall 126 so as to extend farther horizontally away from the wall than does the front edge 122 of the top surface of the mantel 120. That is, the mounting bracket allows for the television or display 102 to be moved horizontally outward away from the wall 126 so as to clear (or extend horizontally farther than the wall 126 than) the mantel 120.

Further, also described in further detail below, the mounting bracket permits the television or display 102, according to embodiments described herein, to be repositioned (via motion that is independent from the above-described horizontal or linear/y-axis direction motion) from an upward or vertical position (for example, vertically positioned above the top surface of the mantel 120 as in FIG. 1) outward and downward in an arc in a z-y plane so as to move the television or display 102 rotatively downward to a vertically lower position in relation to the wall 126 and the floor 130.

Next, FIG. 2 provides a perspective view 200 from above showing a television or display mounting bracket in a substantially collapsed or stowed position where a scissors portion is collapsed and a rotative (rotating) arm portion is in an upward or vertical stowed position, according to embodiments. The scissors portion, in one embodiment, comprises a plurality of scissor arms (such as scissor arms 220, 222, 224, 226) pivotally connected to a mounting plate 202 at one extensible end of the plurality of scissor arms and pivotally connected to an intermediary plate 228 at an oppositely extensible end of the plurality of scissor arms. In one embodiment, the plurality of scissor arms comprises at least a pair of scissor arms, such as, for example, a first pair of scissor arms comprising a first scissor arm 224 pivotally connected to a second scissor arm 226, with the first and second scissor arms pivotally connected to one another at an end of each arm and with the first and second scissor arms pivotally connected to the intermediary plate 228 and mounting plate 202, respectively, via pivot connections at the ends of the first and second scissor arms that are opposite to the ends of the first and second scissor arms pivotally connected to one another. For example, as shown in FIG. 2, scissor arm 226 may be pivotally connected to the mounting plate 202 via pivot connection 212; scissor arm 224 may be pivotally connected to scissor arm 226 via pivot connection 210; and scissor arm 224 may be pivotally connected to intermediary plate 228 via pivot connection 218. In one embodiment, each of the pivot connections 212, 210, and 218 comprise a pivot axis that is parallel to the z-x plane of the wall or vertical surface 126. In one embodiment, the pivot axis of each of the pivot connections 212, 210, and 218 are parallel to the z-axis or z-axis direction. In one embodiment, the pivot axis of each of the pivot connections (e.g., pivot connections 212, 210, and 218) associated with all scissor arms are parallel to one another and permit rotation of the intermediary plate 228 with respect to the mounting plate 202 (such as rotation of the intermediary plate 228 about a vertical or z-axis), thus permitting the repositioning of a television or display affixed to the mounting bracket to be rotated to the right or to the left. And in one embodiment, the pivot axis of each of the pivot connections 212, 210, and 218 are parallel to the z-x plane of the mounting plate 202 (or the plane comprising the mounting plate 202), and, in addition, may be parallel to a plane formed by the intermediary plate 228.

The mounting plate 202 is shown in FIG. 2 having a planar surface 203 facing away from (opposite of) a mounting plate wall contacting surface (not shown), and having a left side 206 and a top edge 204. The mounting plate 202 may comprise different structures and arrangements so as to provide attachment points for the scissor arms, such as by pivot connection 212. In one embodiment, the intermediary plate 228 comprises a planar surface and structure(s) therefor, as described below.

In one embodiment, the plurality of scissor arms comprises a second pair of scissor arms in addition to the first pair described above. For example, the second pair of scissor arms may comprise, as shown in FIG. 2, a first scissor arm 222 pivotally connected to a second scissor arm 220, with the first and second scissor arms pivotally connected to one another at an end of each arm and with the first and second scissor arms pivotally connected to the intermediary plate 228 and mounting plate 202, respectively, via pivot connections at the ends of the first and second scissor arms that are opposite to the ends of the first and second scissor arms pivotally connected to one another, and as similarly described with respect to the first pair of scissor arms 224 and 226. That is, the second pair of scissor arms 222 and 220, according to one embodiment, is arranged in similar fashion as the scissor arms comprising the first pair of arms 224 and 226. The second pair of scissor arms may be, as shown in FIG. 2, arranged to pivot opposite one another. For example, as the intermediary plate 228 is moved away from the mounting plate 202 (across and within a plane that is orthogonal to the planes of each of the mounting plate 202 and the intermediary plate 228), the rotation (pivoting motion) at the pivot connections 212, 210, and 218 for the first pair of scissor arms 224, 226 is opposite to the rotation (pivoting motion) at the pivot connections 214, 208, and 216 for the second pair of scissor arms 222, 220.

Also illustrated in the perspective view 200 in FIG. 2, in addition to the mounting bracket in a substantially collapsed or stowed position where a scissors portion is collapsed, is a rotative (rotating) arm portion shown in an upward or vertical stowed position, according to embodiments. As shown, at least one rotating arm (such as rotating arm 230) is pivotally connected to the intermediary plate 228 so as to permit rotation of the rotating arm 230 about the rotating (rotative) arm pivot connection 234 to move the rotating arm 230 from an upward or vertical position (when, for example, the television or display 102 is pushed as far inward toward the wall 126 as possible) to an outward and downward position through an arc in a plane that is orthogonal to at least the horizontal or plant parallel to the floor surface 130, and that may further be orthogonal to a plane defined by the outward facing surface of the intermediary plate 120. A pair of rotating arms 230 and 232 (as shown) may be pivotally connected to the intermediary plate 128 and move in parallel to one another so as to permit moving the television or display 102 rotatively (about a pivot axis of the rotating arm pivot connection 234) downward to a vertically lower position in relation to the wall 126 and the floor 130. The rotating pivot connection 234 may comprise a spring or piston or other structure urging the pivot arm 230 back toward its home position or an upward or vertical (stowed) position as shown in FIG. 2. Likewise, a rotating pivot connection similar to or the same as the rotating pivot connection 234 may be used at the pivot connection of the rotating arm 232 where such arm is pivotally connected to the intermediary plate 228.

Turning now to FIG. 3 is a perspective view 300 from above showing a television or display mounting bracket with a scissors portion in an extended position to move the television or display away from a vertical surface mounting plate and with a rotative (rotating) arm portion in an upward or vertical (stowed) position, according to embodiments. In one embodiment, each pair of scissor arms comprising the scissor arm portion may comprise more than one arm member between two pivoting connections. For example, as shown in FIG. 3, the second scissor arm 220 may be coupled with a similarly constructed and oriented lower second scissor arm 220 that is pivotally connected to the first scissor arm 222. In similar fashion, a lower second scissor arm may be associated with the second scissor arm 226 and pivotally connected to the first scissor arm 224.

As shown in FIG. 3, the mounting plate 202 may comprise a planar front surface 203 having side edges (or sides) 206 and 304, and having a top edge 204 and a bottom edge 306. Pivot connections between the mounting plate 202 and the scissor arms, such as pivot connection 214 and pivot connection 212, may be attached to the planar front surface 203 of the mounting plate 202. An intermediary plate bracket 308 may be included for pivotally attaching the scissor arms to a backside 310 of the intermediary plate 228. The intermediary plate bracket 308 may, as shown, support the pivot connections for the scissor arms such as pivot connections 216 and 218 associated with the first arms 222 and 224, respectively.

As arranged in FIG. 3, as the scissor arms are moved, for example, in a y-axis direction (within the horizontal or x-y plane) between the (extended or pulled outward) position shown in FIG. 3 and the (collapsed or compressed) position shown in FIG. 2, the outward most arms (i.e., the first arms 222 and 224) nest between the arms pivotally connected to the mounting plate 202. For example, as the intermediary plate 228 is moved toward the mounting plate 202, the first arm 222 nests between the second arm 220 and the lower second arm 316.

Also depicted in FIG. 3 is the rotative (rotating) arm portion comprising rotating arms 230 and 232 positioned in an upward or vertical (stowed) position. As shown, the rotating arm 230 extends from a lower end 312 (proximate to the rotating arm pivot connection 234) upward along the back surface 302 of the television or display; and the rotating arm 232 likewise extends from a lower end 314 (proximate to a rotating arm pivot connection similar to the rotating arm pivot connection 234) upward along the back surface 302.

Moving to FIG. 4 is a perspective view 400 from above showing the television or display mounting bracket with a scissors portion in an extended position to separate the mounting plate 202 and an intermediary plate 228, and with a rotative (rotating) arm portion (comprising rotating arms 230 and 232, which rotate about an axis 402 associated with the intermediary plate 228) rotated from an upward or vertical position to an outward positon such that the television or display is away from and downward in relation to the intermediary plate 228. As shown, the rotating arms 230 and 232 are moved from the upward or vertical position to the illustrated position rotated by an angle 404. The angle (or range of rotation) 404 is the angle between the plane of the intermediary plate 228 or a vertical side of the intermediary plate 228 such as side edge 420 and the rotating arm 230. In one embodiment, the range of the angle 404 is from zero degrees to 90 degrees. That is, the rotating arm 230 is able to move throughout a range from vertical (i.e., zero degrees from vertical) to 90 degrees from vertical. In another embodiment, the range of the angle of rotation 404 is from zero degrees to 120 degrees, so that the rotating arm is movable from a vertical (or collapsed or stowed) position to a position that is 120 degrees from vertical (or an orientation at which the rotating arm, for example rotating arm 230, is positioned outward and vertically downward in order to reposition the television or display farther outward from the mounting plate 202 and vertically downward toward the floor surface 130.

As shown in FIG. 4, the rotating arm 230 extends from the end 312 at the intermediary plate 228 to an opposite end 412 at the back surface 302 of the television or display, where the rotating arm 230 is pivotally attached to the back surface 302 via a pivoting connector 408. The rotating arm 232 likewise extends from the end 314 at the intermediary plate 228 to an opposite end 410 at the back surface 302 of the television or display, where the rotating arm 232 is pivotally attached to the back surface 302 via a pivoting connector 406. A rod or pivoting support 414 may be included that extends between opposite ends 416 and 418 across a portion of the width of the back side 302 of the television or display. Each of the pivot connectors 408 and 406 may comprise, for example, a pivot clamp that permits the television or display to be repositioned about an axis extending between the pivot connectors 408 and 406 such that the television or display screen 102 may be repositioned when the rotating arms 230 and 232 are rotated between the upward or vertical position and the outward position.

Lastly, FIG. 5 is a perspective view 500 from above and in front of the television or display and mounting bracket illustrated in FIG. 4. That is, FIG. 5 shows the television or display from the front and as attached to rotative (rotating) and scissors portions of a television or display mounting bracket. As shown, the front screen 102 of the television or display is in a vertically lower position relative to the front surface 502 of the intermediary plate 228 and the front surface 203 of the mounting plate 202. In such a position, the television or display screen 102 is positioned vertically lower relative to the wall 126 or vertical surface mounting plate 202 than when the rotating arms (rotative portion) are (as shown in FIGS. 1-3) in an upward or vertical orientation relative to the wall and intermediary plate.

Thus, as the present inventor discovered, the arrangement of scissor arms that extend outward from a vertical mounting surface, rotative (rotating) arms that move in an arc downward from a vertical stowage or stowed position to an outward or deployed position, and pivoting connectors between the outward ends of the rotative (rotating) arms of the mounting bracket and the back surfaces of the television or display provides advantages over prior television or display mounting devices and methods. In this way, as the present inventor discovered, a television or video display wall mounting bracket or rack is disclosed having improved rotative and expansive motion so that the display or television screen may be moved (horizontally) away from and (rotatively vertically) downward from the wall, to viewing positions away from, for example, a mantel or other wall-positioned furniture.

In one embodiment, a television or display mounting bracket comprises a mounting plate configured to be mountable to a vertical surface, a plurality of scissor arms interconnected with one another and to the mounting plate so that the plurality of scissor arms moves within a scissors plane that is non-parallel to the vertical surface, an intermediary plate connected to at least one of the plurality of scissor arms and configured to move within the scissors plane along with the at least one of the plurality of scissor arms, at least one rotating arm pivotally connected to the intermediary plate and configured such that each of the at least one rotating arm moves within a rotating arm plane that is non-parallel to the scissors plane, and at least one pivoting connector of the at least one rotating arm configured to be connectable to the television or display so that the television or display, when connected to the at least one pivoting connector, is movable in relation to the vertical surface via the plurality of scissor arms and, independently, via the at least one rotating arm.

In one embodiment, the scissors plane is orthogonal to the vertical surface, whereby the intermediary plate is extendable within the scissors plane so as to selectively extend the intermediary plate away from the mounting plate and retract the intermediary plate toward the mounting plate, thereby varying a distance between the vertical surface and the intermediary plate.

In one embodiment, the vertical surface comprises a wall surface and the scissors plane is horizontal and parallel with a floor surface, and wherein the mounting bracket permits extending the television or display, when connected to the mounting bracket via the at least one pivoting connector, outward from or inward to the wall within a horizontal range of motion parallel to the floor.

In one embodiment, the rotating arm plane is orthogonal to the scissors plane, whereby the at least one rotating arm is pivotally rotatable with respect to an axis of rotation on the intermediary plate so as to permit the at least one rotating arm to rotate between at least an upward or vertical position and an outward position, wherein, in the upward or vertical position, the at least one rotating arm is oriented such that the at least one pivoting connector is closer to the vertical surface than when the at least one rotating arm is in the outward position.

In one embodiment, the vertical surface comprises a wall surface and the scissors plane is horizontal and parallel with a floor surface, wherein the mounting bracket permits extending the television or display, when connected to the mounting bracket via the at least one pivoting connector, outward from or inward to the wall within a horizontal range of motion parallel to the floor surface via movement of the plurality of scissor arms, wherein the axis of rotation of on the intermediary plate is horizontal and parallel with the floor surface, and wherein the at least one rotating arm is rotatable about the axis of rotation of the intermediary plate so that the television or display, when connected to the mounting bracket via the at least one pivoting connector, is movable along an arc within the rotating arm plane in order to reposition the television or display farther outward from the wall and vertically downward toward the floor surface as the at least one rotating arm moves from the upward or vertical position to the outward position.

In one embodiment, the mounting plate comprises one or more planar structure to which the plurality of scissor arms are interconnected.

In one embodiment, the plurality of scissor arms comprises a pair of scissor arms interconnected with one another so that one end of the pair of scissor arms connects to the mounting plate and another end of the pair of scissor arms connects to the intermediary plate and so as to permit the intermediary plate to be selectively moved away from or moved closer to the mounting plate.

In one embodiment, the pair of scissor arms comprises a pair of articulated arms, the pair of articulated arms having a first arm pivotally attached to the mounting plate, a second arm pivotally attached to the first arm, and the second arm pivotally attached to the intermediary plate.

In one embodiment, the scissor arms are interconnected with the mounting plate and the intermediary plate so as to permit the scissor arms to move within a horizontal plane that is orthogonal to the vertical surface and parallel to a floor surface.

In one embodiment, the intermediary plate comprises a horizontally oriented axis of rotation and the at least one rotating arm comprises a pair of rotating arms with each rotating arm pivotally connected to the intermediary plate via the horizontal axis of rotation and configured so that both rotating arms move together in relation to one another so that the television or display, when connected to the mounting bracket via the at least one pivoting connector, is movable along an arc within the rotating arm plane in order to reposition the television or display farther outward from the wall and vertically downward toward the floor surface as the at least one rotating arm moves from the upward or vertical position to the outward position.

In one embodiment, the at least one rotating arm comprises a longitudinally extending arm pivotally connected to the intermediary plate at a rotating arm pivot point at one end and having one of the at least one pivoting connector at the other, wherein the rotating arm pivot point includes a piston or spring force configured to urge rotation of the rotating arm toward the upward or vertical position and resist rotation of the rotating arm toward the outward position.

In one embodiment, the television or display comprises an x-y-z coordinate system wherein an x-axis comprises a width of the television or display and is horizontal and parallel to the floor, a y-axis is orthogonal to the x-axis and extends between a front and a rear surface of the television or display, a z-axis is orthogonal to the x-axis and the y-axis and extends vertically between a top edge and a bottom edge of the television or display, wherein the bracket allows for repositioning the television or display in a y-axis direction via the scissor arms and rotating the television or display within an arc in a z-y plane, wherein the vertical surface comprises a z-x plane that is orthogonal to a horizontal or floor surface that comprises an x-y plane, wherein the bracket is configured so as to be movable in the y-axis direction away from the vertical surface via the scissor arms, and, independent of the movement in the y-axis direction via the scissor arms, movable about an arc of rotation about an x-axis.

In one embodiment, a method of using a television or display mounting bracket includes providing a television or display and attaching the television or display to a wall using a television or display mounting bracket as previously described, pulling the television or display outward in the y-direction, rotating the television or display outward and downward in the arc in the z-y plane; and tilting the television or display by rotating the television or display about the x-axis.

In one embodiment, moving the television or display in y-direction comprises pulling the television or display away from a wall to a distance sufficient to clear a top surface and front edge of a mantel positioned vertically below the mounting bracket.

FIGS. 1-5 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

Certain adaptations and modifications of the described embodiments can be made. Therefore, the above discussed embodiments are considered to be illustrative and not restrictive. The present disclosure is not to be limited in scope by the specific embodiments described herein. Further example embodiments may also include all of the steps, features, compositions and compounds referred to or indicated in this description, individually or collectively and any and all combinations or any two or more of the steps or features.

Throughout this document, the use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more. The words “comprising” (and any form of comprising, such as “comprise’ and comprises), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

In the present specification and in the appended claims, various terminology which is directional, geometrical and/or spatial in nature such as “longitudinal”, “horizontal”, “front”, “forward”, “backward”, “back”, “rear”, “upwardly”, “downwardly”, etc. is used. It is to be understood that such terminology is used for ease of description and in a relative sense only and is not to be taken in any way as specifying an absolute direction or orientation.

The embodiments described herein may include one or more range of values (for example, size, displacement and field strength etc.). A range of values will be understood to include all values within the range, including the values defining the range, and values adjacent to the range that lead to the same or substantially the same outcome as the values immediately adjacent to that value which defines the boundary to the range. For example, a person skilled in the field will understand that a 10% variation in upper or lower limits of a range can be totally appropriate and is encompassed by the disclosure. More particularly, the variation in upper or lower limits of a range will be 5% or as is commonly recognized in the art, whichever is greater.

Throughout this specification relative language such as the words ‘about’ and ‘approximately’ are used. This language seeks to incorporate at least 10% variability to the specified number or range. That variability may be plus 10% or negative 10% of the particular number specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

What is claimed is:

1. A television or display mounting bracket, comprising:
a mounting plate configured to be mountable to a vertical surface;
a plurality of scissor arms interconnected with one another and to the mounting plate so that the plurality of scissor arms moves within a scissors plane that is non-parallel to the vertical surface;
an intermediary plate connected to at least one of the plurality of scissor arms and configured to move within the scissors plane along with the at least one of the plurality of scissor arms;
at least one rotating arm pivotally connected to the intermediary plate and configured such that each of the at least one rotating arm moves within a rotating arm plane that is non-parallel to the scissors plane; and
at least one pivoting connector of the at least one rotating arm configured to be connectable to the television or display so that the television or display, when connected to the at least one pivoting connector, is movable in relation to the vertical surface via the plurality of scissor arms and, independently, via the at least one rotating arm.

2. The mounting bracket of claim 1, wherein the scissors plane is orthogonal to the vertical surface, whereby the intermediary plate is extendable within the scissors plane so as to selectively extend the intermediary plate away from the mounting plate and retract the intermediary plate toward the mounting plate, thereby varying a distance between the vertical surface and the intermediary plate.

3. The mounting bracket of claim 2, wherein the vertical surface comprises a wall surface and the scissors plane is horizontal and parallel with a floor surface, and wherein the mounting bracket permits extending the television or display, when connected to the mounting bracket via the at least one pivoting connector, outward from or inward to the wall within a horizontal range of motion parallel to the floor.

4. The mounting bracket of claim 1, wherein the rotating arm plane is orthogonal to the scissors plane, whereby the at least one rotating arm is pivotally rotatable with respect to an axis of rotation on the intermediary plate so as to permit the at least one rotating arm to rotate between at least an upward or vertical position and an outward position, wherein, in the upward or vertical position, the at least one rotating arm is oriented such that the at least one pivoting connector is closer to the vertical surface than when the at least one rotating arm is in the outward position.

5. The mounting bracket of claim 4, wherein the vertical surface comprises a wall surface and the scissors plane is horizontal and parallel with a floor surface, wherein the mounting bracket permits extending the television or display, when connected to the mounting bracket via the at least one pivoting connector, outward from or inward to the wall within a horizontal range of motion parallel to the floor surface via movement of the plurality of scissor arms, wherein the axis of rotation of on the intermediary plate is horizontal and parallel with the floor surface, and wherein the at least one rotating arm is rotatable about the axis of rotation of the intermediary plate so that the television or display, when connected to the mounting bracket via the at least one pivoting connector, is movable along an arc within the rotating arm plane in order to reposition the television or display farther outward from the wall and vertically downward toward the floor surface as the at least one rotating arm moves from the upward or vertical position to the outward position.

6. The mounting bracket of claim 1, wherein the mounting plate comprises one or more planar structure to which the plurality of scissor arms are interconnected.

7. The mounting bracket of claim 1, wherein the plurality of scissor arms comprises a pair of scissor arms interconnected with one another so that one end of the pair of scissor arms connects to the mounting plate and another end of the pair of scissor arms connects to the intermediary plate and so as to permit the intermediary plate to be selectively moved away from or moved closer to the mounting plate.

8. The mounting bracket of claim 7, wherein the pair of scissor arms comprises a pair of articulated arms, the pair of articulated arms having a first arm pivotally attached to the mounting plate, a second arm pivotally attached to the first arm, and the second arm pivotally attached to the intermediary plate.

9. The mounting bracket of claim 7, wherein the scissor arms are interconnected with the mounting plate and the intermediary plate so as to permit the scissor arms to move within a horizontal plane that is orthogonal to the vertical surface and parallel to a floor surface.

10. The mounting bracket of claim 5, wherein the intermediary plate comprises a horizontally oriented axis of rotation and the at least one rotating arm comprises a pair of rotating arms with each rotating arm pivotally connected to the intermediary plate via the horizontal axis of rotation and configured so that both rotating arms move together in relation to one another so that the television or display, when connected to the mounting bracket via the at least one pivoting connector, is movable along an arc within the rotating arm plane in order to reposition the television or display farther outward from the wall and vertically downward toward the floor surface as the at least one rotating arm moves from the upward or vertical position to the outward position.

11. The mounting bracket of claim 10, wherein the at least one rotating arm comprises a longitudinally extending arm pivotally connected to the intermediary plate at a rotating arm pivot point at one end and having one of the at least one pivoting connector at the other, wherein the rotating arm pivot point includes a piston or spring force configured to urge rotation of the rotating arm toward the upward or vertical position and resist rotation of the rotating arm toward the outward position.

12. The mounting bracket of claim 1, wherein the television or display comprises an x-y-z coordinate system wherein an x-axis comprises a width of the television or display and is horizontal and parallel to a floor, a y-axis is orthogonal to the x-axis and extends between a front and a rear surface of the television or display, a z-axis is orthogonal to the x-axis and the y-axis and extends vertically between a top edge and a bottom edge of the television or display, wherein the bracket allows for repositioning the television or display in a y-axis direction via the scissor arms and rotating the television or display within an arc in a z-y plane, wherein the vertical surface comprises a z-x plane that is orthogonal to a horizontal or floor surface that comprises an x-y plane, wherein the bracket is configured so as to be movable in the y-axis direction away from the vertical surface via the scissor arms, and, independent of the movement in the y-axis direction via the scissor arms, movable about an arc of rotation about an x-axis.

13. A method of using a television or display mounting bracket, the method comprising:
providing a television or display and attaching the television or display to a wall using a television or display mounting bracket according to claim 12;
pulling the television or display outward in the y-direction;
rotating the television or display outward and downward in the arc in the z-y plane; and
tilting the television or display by rotating the television or display about the x-axis.

14. The method of claim 13, wherein moving the television or display in y-direction comprises pulling the television or display away from a wall to a distance sufficient to clear a top surface and front edge of a mantel positioned vertically below the mounting bracket.

15. The method of claim 13, wherein the scissors plane is orthogonal to the vertical surface, whereby the intermediary plate is extendable within the scissors plane so as to selectively extend the intermediary plate away from the mounting plate and retract the intermediary plate toward the mounting plate, thereby varying a distance between the vertical surface and the intermediary plate.

16. The method of claim 15, wherein the vertical surface comprises a wall surface and the scissors plane is horizontal and parallel with a floor surface, and wherein the mounting bracket permits extending the television or display, when connected to the mounting bracket via the at least one pivoting connector, outward from or inward to the wall within a horizontal range of motion parallel to the floor.

17. The method of claim 13, wherein the rotating arm plane is orthogonal to the scissors plane, whereby the at least one rotating arm is pivotally rotatable with respect to an axis of rotation on the intermediary plate so as to permit the at least one rotating arm to rotate between at least an upward or vertical position and an outward position, wherein, in the upward or vertical position, the at least one rotating arm is oriented such that the at least one pivoting connector is closer to the vertical surface than when the at least one rotating arm is in the outward position.

18. The method of claim 17, wherein the vertical surface comprises a wall surface and the scissors plane is horizontal and parallel with a floor surface, wherein the mounting bracket permits extending the television or display, when connected to the mounting bracket via the at least one pivoting connector, outward from or inward to the wall within a horizontal range of motion parallel to the floor surface via movement of the plurality of scissor arms, wherein the axis of rotation of on the intermediary plate is horizontal and parallel with the floor surface, and wherein the at least one rotating arm is rotatable about the axis of rotation of the intermediary plate so that the television or display, when connected to the mounting bracket via the at least one pivoting connector, is movable along an arc within the rotating arm plane in order to reposition the television or display farther outward from the wall and vertically downward toward the floor surface as the at least one rotating arm moves from the upward or vertical position to the outward position.

19. The method of claim 18, wherein the intermediary plate comprises a horizontally oriented axis of rotation and the at least one rotating arm comprises a pair of rotating arms with each rotating arm pivotally connected to the intermediary plate via the horizontal axis of rotation and configured so that both rotating arms move together in relation to one another so that the television or display, when connected to the mounting bracket via the at least one pivoting connector, is movable along an arc within the rotating arm plane in order to reposition the television or display farther outward from the wall and vertically downward toward the floor surface as the at least one rotating arm moves from the upward or vertical position to the outward position.

20. The method of claim 19, wherein the at least one rotating arm comprises a longitudinally extending arm pivotally connected to the intermediary plate at a rotating arm pivot point at one end and having one of the at least one pivoting connector at the other, wherein the rotating arm pivot point includes a piston or spring force configured to urge rotation of the rotating arm toward the upward or vertical position and resist rotation of the rotating arm toward the outward position.
